(19) United States
(12) Patent Application Publication
(10) Pub. No.: US 2026/0275735 A1
(43) Pub. Date: Sep. 17, 2026

(54) METHOD AND DEVICE FOR INSTALLING AN ESCALATOR OR A MOVING WALKWAY ON A RECEIVING STRUCTURE INTEGRATED IN A BUILDING

(71) Applicant: INVENTIO AG, Hergiswil (CH)

(72) Inventor: Georg Wagenleitner, Rossleithen (CH)

(21) Appl. No.: 19/162,048

(22) PCT Filed: Apr. 3, 2024
(86) PCT No.: PCT/EP2024/059079

§ 371 Date: Sep. 3, 2025

(30) Foreign Application Priority Data
Apr. 28, 2023 (EP) 23170521.1

(51) Int. Cl. E04G 21/18; B66B 23/14; B66B 31/00

(52) U.S. Cl. CPC E04G 21/185; B66B 23/14; B66B 31/00

(57) ABSTRACT

The invention relates to a method for installing a passenger transport system in the form of an escalator or a moving walkway on a provided receiving structure and to a device configured for this purpose. The method comprise determining geometrical data and/or structural data for the provided receiving structure by automatically measuring the provided receiving structure, for example using a measuring apparatus equipped with a 3D scanner; automatically selecting supporting components provided for holding, supporting and/or guiding a conveyor belt relative to the provided receiving structure in a plurality of different fixing along the transport path, and automatically determining a plurality of different fixing positions along the provided receiving structure, taking into account the geometrical data and/or structural data determined, based on properties of selected supporting components; and fixing each selected supporting component at an assigned fixing position, for example using a fixing apparatus equipped with a robot.

The present invention relates to a method and to a device for installing a passenger transport system in the form of an escalator or a moving walkway in a building. Moving walkways and escalators are used to transport passengers along a transport path. In a moving walkway, the transport path is usually horizontal or at only a slight inclination, whereas the transport path is at a greater inclination in an escalator. The transport path can, for example, run within a building or structure in order to transport passengers over longer distances and, in the case of escalators, across considerable differences in height. An escalator has a conveyor belt in the form of a step belt having a plurality of tread units in the form of steps coupled to one another. In a moving walkway, the conveyor belt is in the form of a pallet belt and the tread units are designed as pallets. At each of the opposite ends of the transport path, the passenger transport system has access regions through which passengers can access the conveyor belt. In addition to or as an alternative to transporting passengers, the moving walkway or escalator can also transport objects, animals or the like.

Conventional escalators or moving walkways usually have a supporting structure in the form of a truss made up of interconnected steel components, such as upper chords, lower chords, struts, uprights, etc. In this case, the truss is dimensioned and configured in such a way that it can absorb all of the forces acting on the passenger transport system, including its own weight, and transfer them to the surrounding building. The truss, including any supporting components attached thereto, is designed in particular to hold, support and/or guide the conveyor belt. The truss is produced separately from the building as a standalone component, this of course taking into account conditions prevailing within the building, and is then installed in the building, i.e. generally mounted on bearing points in the building. However, the production or provision of such a supporting structure in the form of a truss is very complex and, since it is usually a unique piece configured specifically for the order, its manufacturing costs are very high. In addition, the truss is usually produced in advance and must then be transported as a very large component and installed in the building to be equipped with the passenger transport system. WO2021/052743 A1 describes an alternative approach in which a standard steel truss is replaced, for example, by a concrete supporting structure, which can also be produced directly on-site using prefabricated truss formwork or 3D printing robots.

EP 2 900 585 B1 describes another approach to a track system for an escalator or moving walkway. Structures integrated into a building are used as support structures for receiving a passenger transport system.

WO 2015/037070A1 , GB 2 121 748 A, WO 2021/11549 A1 and EP 3 792 427 A1 disclose further methods for installing an escalator or moving walkway in a building.

However, even with the alternative approaches mentioned, installing the passenger transport system in the building is usually labor-intensive and/or cost-intensive.

There may be a need for a method of installing a moving walkway or escalator which, among other things, avoids at least some of the above-mentioned problems of conventional approaches. In particular, there may be a need for methods by which a moving walkway or escalator can be installed at least partially automatically in a low-effort, cost-effective, safe and/or reliable manner. Furthermore, there may be a need for a device configured for installing moving walkways or escalators in this way.

Such a need can be met by the subject matter according to the independent claims.

Advantageous embodiments are defined in the dependent claims and in the following description or are illustrated in the accompanying figures.

According to a first aspect of the invention, a method is described for installing a passenger transport system in the form of an escalator or a moving walkway on a receiving structure that is provided, which structure is integrated in a building in order to hold the passenger transport system. The passenger transport system comprises at least one conveyor belt for transporting passengers along a transport path and a plurality of supporting components for holding, supporting and/or guiding the conveyor belt along the transport path relative to the provided receiving structure. The method comprises at least the following method steps, preferably in the sequence provided:
determining geometrical data and/or structural data for the provided receiving structure by automatically measuring the provided receiving structure using a measuring apparatus,
automatically selecting supporting components from a plurality of available supporting components, which are provided for holding, supporting and/or guiding the conveyor belt relative to the provided receiving structure at a plurality of different fixing positions along the transport path, and automatically determining a plurality of different fixing positions along the provided receiving structure, taking into account the geometrical data and/or structural data determined, on the basis of properties of the chosen supporting components, and
fixing each of the chosen supporting components at an assigned fixing position of the plurality of fixing positions determined on the provided receiving structure.

According to a second aspect of the invention, a device is described for installing a passenger transport system in the form of an escalator or a moving walkway on a receiving structure that is provided, which structure is integrated in a building in order to hold the passenger transport system. The passenger transport system comprises a conveyor belt for transporting passengers along a transport path and a plurality of supporting components for holding, supporting and/or guiding the conveyor belt relative to the provided receiving structure. The device comprises at least the following components:
a measuring apparatus for determining geometrical data and/or structural data for the provided receiving structure by automatically measuring the provided receiving structure;
a data processing apparatus for automatically selecting supporting components from a plurality of available supporting components, which are provided for holding, supporting and/or guiding the conveyor belt relative to the provided receiving structure at a plurality of different fixing positions along the transport path, and for automatically determining a plurality of different fixing positions along the provided receiving structure, taking into account the geometrical data and/or structural data determined, on the basis of properties of the chosen supporting components; and
a fixing apparatus for fixing each of the chosen supporting components at an assigned fixing position of the plurality of fixing positions determined on the provided receiving structure.

By way of introduction, a basic idea for embodiments of the invention described herein will be briefly explained; this explanation is to be interpreted as merely a rough summary and not as limiting the invention:

Embodiments of the installation method described herein are intended to use a receiving structure that is provided, for example in the form of a concrete support structure, which is already pre-integrated into a building on-site, in order to mount a passenger transport system thereon. Modern measurement technologies, modern digitalization options and/or installation robots are intended to be used to automate the installation process as much as possible. Using measurement technologies, properties of the provided receiving structure can be determined. On the basis of the properties determined, suitable supporting components can then be selected for suitably attaching the conveyor belt of the passenger transport system to the support structure provided in the building. In addition, the properties determined can be taken into account to set the fixing positions at which these supporting components are to be attached to the provided receiving structure. When selecting the supporting components and fixing positions, for example, the actual external geometry of the support structure provided and/or information about structures within the support structure provided can be taken into account. The suitably selected supporting components can then be provided and fixed at the set fixing positions on the support structure provided. The measurement of the support structure provided and the selection of the supporting components and fixing positions as well as the subsequent fixing of the supporting components can be carried out largely, or even entirely, automatically. This allows, among other things, installation effort to be significantly reduced and, at the same time, installation reliability to be improved. Constructing the provided receiving structure on-site and thereby at least partially replacing a conventional supporting structure involves a very large amount of local production, which is an important award criterion, especially when awarding public contracts.

In the following, possible designs and advantages of embodiments of the installation method and a device that can be used for this purpose will be described in more detail.

The passenger transport system can be an escalator or moving walkway. It is designed to transport passengers and/or objects along a transport path by means of the conveyor belt.

The transport path is located between access regions located at opposite ends of the transport path, via which passengers access the conveyor belt. In the case of an escalator, the conveyor belt is designed as a step belt and comprises a plurality of tread units in the form of steps. In the case of a moving walkway, the conveyor belt is designed as a pallet belt and comprises a plurality of tread units in the form of pallets. The tread units are arranged one behind the other along the transport path and are coupled, for example, by a chain that connects them so that they can be moved synchronously along the transport path. At opposite ends of the transport path, the conveyor belt is typically deflected so that it can be moved in a revolving manner as an endless belt. The conveyor belt moves from one of the access regions to the opposite access region and is usually deflected beneath the access regions. The access regions can be designed with floor plates via which passengers can get to the conveyor belt. A comb plate may be provided at a transition between the conveyor belt and an adjacent access region. A balustrade can run alongside the conveyor belt. The balustrade can extend from one access region to the opposite access region. A handrail may be provided on the balustrade.

The provided receiving structure, which is to be used to hold the passenger transport system within the building, is an integral part of the building. For example, the provided receiving structure can be designed as far back as during the design stage of the building and constructed when constructing the building. The provided receiving structure can be formed in one piece with other building parts, such as floors, walls or ceilings. The receiving structure itself that is provided can also be formed in one piece. Within the building, the provided receiving structure can be separate, i.e. spatially separated, from the other parts of the building. For example, the provided receiving structure can be provided in the building as an integrated concrete supporting structure, for example in the form of a concrete trough.

The provided receiving structure can extend within the building over a distance which substantially corresponds to the transport path to be realized by the passenger transport system. In the case of an escalator, the provided receiving structure can, for example, extend between two floors of the building. The provided receiving structure can be configured in such a way that, in addition to its own weight, it can also absorb a maximum load generated by the passenger transport system, in particular the weight of the passenger transport system and the weight of passengers using the passenger transport system, and can transfer it to surrounding parts of the building. In other words, the statics of the provided receiving structure can be sufficiently dimensioned to be able to transfer forces acting on the passenger transport system during operation into the statics of the building.

During the installation method, a plurality of suitable supporting components can then be attached to the receiving structure already provided in the building at suitable fixing positions in order to be used to ultimately hold or support the conveyor belt of the passenger transport system on the provided receiving structure and, if necessary, guide it along the transport path. The supporting components can be at least partially standardized components. The supporting components can be kept in stock as a range consisting of a plurality of available components. Such a range can include supporting components, such as retaining profiles, retaining plates, anchor components, rails, brackets, console structures, etc. Some of the supporting components, in particular the larger supporting components, such as rails, console structures, etc., can be kept in stock as standard components, preferably of the same type, which can be used in many different passenger transport systems. Other supporting components, such as retaining profiles, retaining plates, anchor components, brackets, fastening flanges, shims, etc., can be kept in stock, for example, as a type of adapter that can be used to fasten the aforementioned standard components to the provided receiving structure, wherein individual conditions of a receiving structure can be taken into account for a specific passenger transport system. For example, the supporting components acting as adapters can be used to bridge gaps, in a load-bearing manner, between the supporting components acting as standard components and a fixing position where they are to be fastened to the provided receiving structure.

As part of the installation method, geometrical data and/or structural data for the provided receiving structure are first determined by automatically measuring the provided receiving structure.

The geometric data in particular reflect external geometric properties of the provided receiving structure. For example, the geometrical data can represent positions of walls or surfaces of the provided receiving structure. Alternatively or additionally, the geometrical data may represent relative positions between different parts of the provided receiving structure, i.e., for example, distances, orientations, etc. of walls or surfaces of different parts of the provided receiving structure relative to one another. Furthermore, the geometrical data can represent information relating to any external structures, such as projections or depressions, textures or the like, on the provided receiving structure, in particular their height or depth, width, orientation, spacing from adjacent structures, etc.

The structural data reflect in particular structural properties, for example internal properties, of the provided receiving structure. For example, the structural data can reflect a material type, a material distribution, etc. within the provided receiving structure. In particular, the structural data can reflect information, for example, about the position, type, orientation, spacing, dimensions, etc. of reinforcements within the receiving structure, which is preferably designed as a concrete supporting part.

To determine the geometrical data and/or structural data, the device has a measuring apparatus which is configured to automatically, that is semi-automatically or preferably fully automatically, measure the provided receiving structure. Different technologies can be used for this measurement. Preferably, the provided receiving structure is measured without touching it. For example, optical, acoustic, inductive, capacitive, radiological and/or other measuring methods can be used. In particular, the provided receiving structure can be measured using modern 3D scanning technologies, for example using a laser scanner, a LiDAR (light detection and ranging), a TOF (time-of-flight) camera or similar. The determination of structural data also includes, for example, locating and measuring hidden structures, such as tensioning cables or rebars, embedded in concrete. By means of the measurement process, the actual quality of the provided receiving structure can be determined. In particular, the actually prevailing geometry and/or structure of the provided receiving structure, i.e. its actual properties, can be determined, wherein this may possibly deviate from the pre-planned or designed target geometry or target structure of the provided receiving structure, for example due to production tolerances.

After the geometrical data and/or structural data of the provided receiving structure have been determined automatically, the information obtained are used to targetedly select suitable supporting components and determine fixing positions.

The supporting components are selected from a plurality of available supporting components. These available supporting components can, for example, be designed and, optionally, manufactured and stored, in advance as standard components. Preferably, various supporting components are kept in stock, particularly in the form of standard components and adapter components, which make it possible to hold, support and/or guide the conveyor belt on the provided receiving structure in a wide variety of configurations.

The available supporting components can differ, for example, in terms of their geometric design, their mechanical load-bearing capacity, the materials used therefor, etc.

When selecting supporting components for a specific application, it is possible to take into account, on the basis of the previously determined geometrical data and/or structural data, for example, which of the fixing positions on the provided receiving structure can be used to fix the supporting components. In particular, it is possible to take into account how each supporting component is to be structurally and functionally designed in order to be able to connect a given conveyor belt to the support structure provided at suitable fixing positions.

For example, a fastening position or a fastening bearing can be provided on the conveyor belt, at which a supporting component or a plurality of cooperating supporting components can be connected in order to then be able to use them to fix the conveyor belt to the provided receiving structure at associated fixing positions or anchors provided at said positions. It is also possible to consider the loads that each supporting component is to withstand.

The fixing positions can be selected, for example, by taking into account the geometrical data and/or structural data so that each of the supporting components to be attached in said positions can be attached to the provided receiving structure in an efficient and load-bearing manner. In particular, the fixing positions can be determined in such a way that the supporting components are not connected in the region of a reinforcement integrated, for example, in the provided receiving structure. In addition, the fixing positions can be determined in such a way that at each of the fixing positions the receiving structure is sufficiently stable and resilient to be able to absorb and transfer the forces or loads transmitted by the passenger transport system.

The selection of the supporting components and the determination of the fixing positions are to be largely automatic in this case. For this purpose, for example, information about the available supporting components can be stored in a database and, based on this information and taking into account the previously determined geometrical data and/or structural data of the provided support structure, a decision can then be made, using suitably selected decision criteria and/or algorithms, as to which supporting components should be used and at which fixing positions they should be connected to the provided support structure. The connection of the conveyor belt to the support structure, which is to be realized using the supporting components, as well as the necessary properties of the supporting components to be used, can be determined automatically, for example by calculation, simulation, modeling, etc.

Finally, the selected supporting components are then provided and fixed to the support structure provided in each of the assigned fixing positions. This process can also be partially or fully automated, as explained in more detail below.

According to one embodiment, the determined geometrical data and/or structural data of the provided receiving structure can be transmitted to a designing apparatus in which a digital twin data set is stored, in which data on properties of the passenger transport system to be installed are stored. The various fixing positions along the transport path at which the supporting components are to be fixed are determined taking into account data from the digital twin data set. One embodiment of the device has a data communication apparatus for this purpose. This is configured to transmit data, in particular the determined geometrical data and/or structural data of the provided receiving structure, to the designing apparatus in which the digital twin data set is stored and/or to receive data from the designing apparatus.

In other words, data communication to a database can be used as a possible way of determining the various fixing positions on the provided receiving structure. The database contains a digital twin data set (sometimes also referred to as a “digital twin”) for the passenger transport system to be created. The database can be part of a designing apparatus used to specify or determine the target properties and/or actual properties of the passenger transport system to be produced. The designing apparatus or its database can, for example, be arranged in a remote computer, which can, for example, be part of a data cloud.

The digital twin data set stored in the designing apparatus contains data and information regarding structural and/or functional properties of the passenger transport system to be produced. For example, the digital twin data set can store information relating to various components of the conveyor belt as well as to various supporting components of the passenger transport system. The information may represent details about the geometric designs of each of the conveyor belt components or supporting components, materials used therein, resulting properties, types and details of the cooperation between different components, etc. This information may, for example, have been established during the assembly of the passenger transport system. The data in the digital twin data set can thus represent target specifications for the passenger transport system and the components installed therein. These data can then advantageously be used to serve as an additional decision criterion when determining the different fixing positions on the provided receiving structure.

According to a further specific embodiment, data from the digital twin data set can also be taken into account when selecting the supporting components.

In other words, in addition to determining the fixing positions, the supporting components to be used for a specific application can be selected from a plurality of available supporting components in such a way that the information available in the digital twin data set are also taken into account. For example, according to the digital twin data set, standard components can be selected as supporting components for connecting the conveyor belt and, in addition, adapter components can be selected as additional supporting components in order to be able to appropriately connect these standard components to the previously measured provided receiving structure. Information about the passenger transport system, particularly with regard to the conveyor belt components, which are stored in the digital twin data set, can be taken into account.

According to a further specific embodiment, information about the chosen supporting components and/or the fixing positions determined can also be stored in the digital twin data set.

In other words, for example, a previously available digital twin data set, in which only target specifications for the components to be used in the passenger transport system were stored, can be supplemented with actual information as part of an update, which information reflects properties of the actually selected supporting components and/or the actually determined fixing positions. The digital twin data set updated in this way can, for example, realistically represent properties of the fully installed passenger transport system at a later date.

According to one embodiment, the geometrical data and/or structural data can be determined by gradually measuring the provided receiving structure at each of the plurality of different fixing positions along the transport path.

In other words, in order to determine the geometrical data and/or the structural data, the provided receiving structure can be successively suitably measured at the various fixing positions along the transport path that are potential fixing positions and/or are actually identified as being suitable fixing positions.

In particular, according to a specific embodiment, a measuring apparatus can be gradually moved along the transport path on the provided receiving structure for measuring purposes. For this purpose, one embodiment of the device to be used here can have a drive in its measuring apparatus for displacing the measuring apparatus along the transport path on the provided receiving structure.

In other words, to carry out the described installation method, a measuring apparatus can be moved along the transport path to be spanned by the passenger transport system and can gradually measure the provided receiving structure in different positions along this transport path. The provided receiving structure can be continuously measured along the entire transport path. Alternatively, the provided receiving structure can be measured at positions spaced apart from one another along the transport path, wherein these positions can, for example, have a sufficiently short distance from one another, for example less than 1 m, preferably less than 0.5 m or less than 0.2 m.

In order to be able to displace the measuring apparatus used for this purpose along the transport path, said apparatus can have its own drive or a drive assigned thereto. On the one hand, the drive can be configured to be able to displace the measuring apparatus or even the entire device along the provided receiving structure. For example, the drive can drive wheels, chains or similar devices provided on the measuring apparatus or the device for this purpose. Alternatively, the drive can drive a winch onto which, for example, a rope attached to a fixed point on the passenger transport system or the surrounding building can be wound in order, in this way, to move the measuring apparatus or device coupled to the rope along the support structure provided. On the other hand, the drive can be configured to provide information about the current position of the measuring apparatus or device moved thereby so that all of the geometrical data and/or structural data automatically determined by the measuring apparatus can be assigned to the current position along the transport path on the provided receiving structure.

According to one embodiment, each of the chosen supporting components are automatically fixed at the assigned fixing position of the plurality of different fixing positions on the provided receiving structure by means of a robot. For this purpose, one embodiment of the device can comprise a robot on its fixing apparatus, which is configured for automatically fixing each of the selected supporting components at the respectively assigned fixing position of the plurality of different fixing positions on the provided receiving structure.

In other words, when installing the passenger transport system, as described herein, a robot can be used to automatically fix the previously selected supporting components at the previously determined fixing positions. The robot may have suitable tools for this purpose. For example, the robot can have a drilling tool in order to be able to drill suitable bores at the fixing positions of the provided receiving structure. Alternatively or additionally, the robot may have an anchoring tool with which an anchor component can be anchored at the corresponding fixing position on the provided receiving structure, for example by attaching, in particular screwing, the anchor component to the previously drilled hole. Furthermore, the robot can have an assembly tool with which further supporting components can be mounted in a previously introduced bore and/or on a previously fixed anchor component. The robot may have a movable arm that allows each tool to be moved relative to a base of the robot. In particular, the robot can have an arm that can be moved and/or pivoted in one, two or three axes. The robot or its arm can have one or more of its own actuators or drives.

According to a further specific embodiment, the robot can be gradually displaced along the transport path on the provided receiving structure and can create an anchoring structure at each fixing position and, optionally, fix an associated supporting component of said supporting components to the anchoring structure. In one embodiment of the device, the fixing apparatus can have a drive for this purpose for displacing the fixing apparatus along the transport path on the provided receiving structure, wherein the robot is configured to create an anchoring structure at each fixing position. Optionally, the robot can be configured to fix a supporting component, which belongs to the anchoring structure created, to the anchoring structure.

In other words, the robot of the device can, similarly to its measuring apparatus, be moved continuously or in suitable steps along the provided receiving structure during the installation process, creating anchoring structures at the various fixing positions and, optionally, attaching supporting components thereto. The robot and the measuring apparatus may, optionally, be part of the same device. Such a device can then be moved once along the provided receiving structure in order to first determine the geometrical data and/or structural data, and then, in a subsequent step, can be moved again along the provided receiving structure in order to then install the supporting components, which have been suitably selected in the meantime, at the fixing positions, which have also been determined in the meantime, by creating anchoring structures and fixing the supporting components to these anchoring structures. Alternatively, the device can be moved along the provided receiving structure in a single pass, first determining the geometrical data and/or structural data and then optionally directly installing, i.e. while the device is still in the same position, a suitable removal component selected in the meantime in this fixing position.

Embodiments of the installation method described herein or the device that can be used for this purpose can enable the following advantages, among others:
The automatic determination of geometric and/or structural data for the provided receiving structure enables quick and precise installation of the passenger transport system. In particular, among other things, a high degree of accuracy of anchoring bores is made possible by a possible combination of, for example, an actual 3D scan of the provided receiving structure, consideration of information from a digital twin of the passenger transport system, and the use of modern robot technology to create connecting bores.
Low susceptibility to errors during the installation of a passenger transport system is achieved, particularly due to a high degree of automation in the method steps to be carried out.
Less material can be used, in particular through a possible massive reduction in load-bearing components or a possible elimination of the truss by the manufacturer of the passenger transport system.
Low transport costs and easy transportation of the passenger transport system to the place of use within a building is possible. Furthermore, easy installation of the passenger transport system into the building is possible, meaning that escalators and moving walkways do not have to be installed at the start of the construction of the building, as is often usually the case.
The approach described here is particularly advantageously used in earthquake zones, i.e. it brings benefits in regions of the world with high seismic activity. In particular, no special earthquake bearing members as an interface between the building and the passenger transport system, or other earthquake measures, are necessary to achieve a protective goal of preserving the integrity of the escalator and the wellbeing of persons on, next to or under the escalator, for example. Here, for example, a concrete structure can be designed according to the same criteria as the rest of the building. No high local force introduction at bearing points is required, since such bearing points are generally no longer present in the approach described herein.

Furthermore, the approach described herein also offers the possibility of reducing CO2 emissions during the production of a passenger transport system. This is due to the fact that the largest percentage of steel in the escalator, which is traditionally required to produce trusses, is no longer needed. On the other hand, new studies have shown that concrete reabsorbs significant amounts of CO2 through the process of natural aging or erosion. A further reduction in CO2 can be achieved during transport due to the possible weight reduction, as fewer containers may be required, for example. This has a positive effect on the carbon footprint of the escalator and the building.

A concrete structure acting as the provided receiving structure can be advantageously protected against the penetration of oils and greases by simple suitable plastics films or solvent-resistant paints.

Higher degrees of balustrade stiffness can be achieved because balustrade components and parts that are normally connected to the truss can be connected to the supporting structure provided, which is considered to be rigid, for example in the form of a concrete structure.

In addition, the on-site construction of the provided receiving structure gives the architectural office designing said passenger transport system considerable design freedom so that the corresponding building region is not dominated by the substantially box-shaped design of conventional passenger transport systems.

It should be noted that some of the possible features and advantages of the invention are described herein with reference to different embodiments of the installation method described herein and with reference to a correspondingly configured device. Those skilled in the art will note that the features can be combined, transferred, adapted or replaced as appropriate in order to arrive at further embodiments of the invention that are covered by the scope of protection defined in the claims.

Embodiments of the invention will be described below with reference to the accompanying drawings, wherein neither the drawings nor the description are intended to be interpreted as limiting the invention.

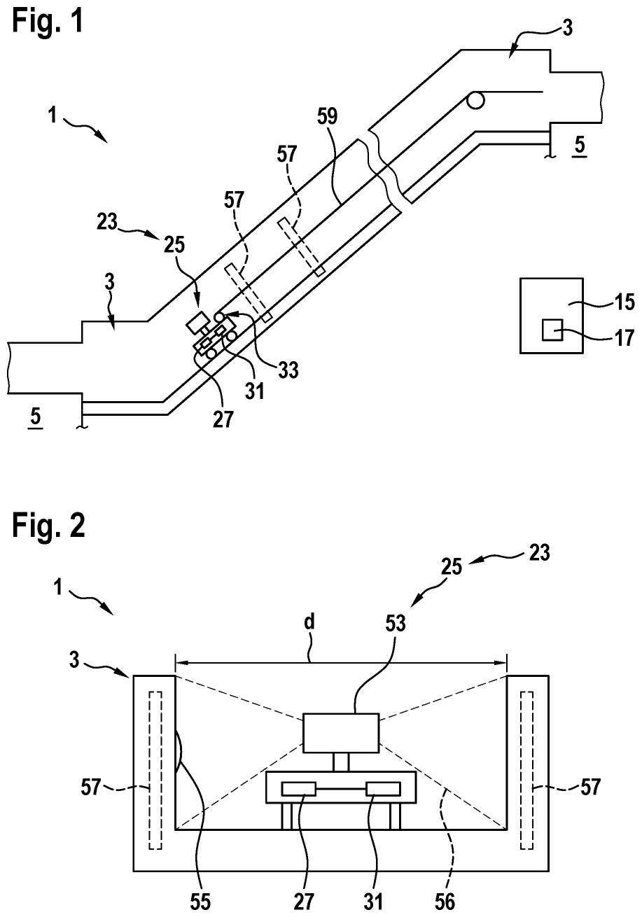

FIG. 1 shows a longitudinal sectional view of a passenger transport system during a measuring stage of an installation method according to one embodiment of the present invention.

FIG. 2 shows a cross-sectional view of the passenger transport system from FIG. 1.

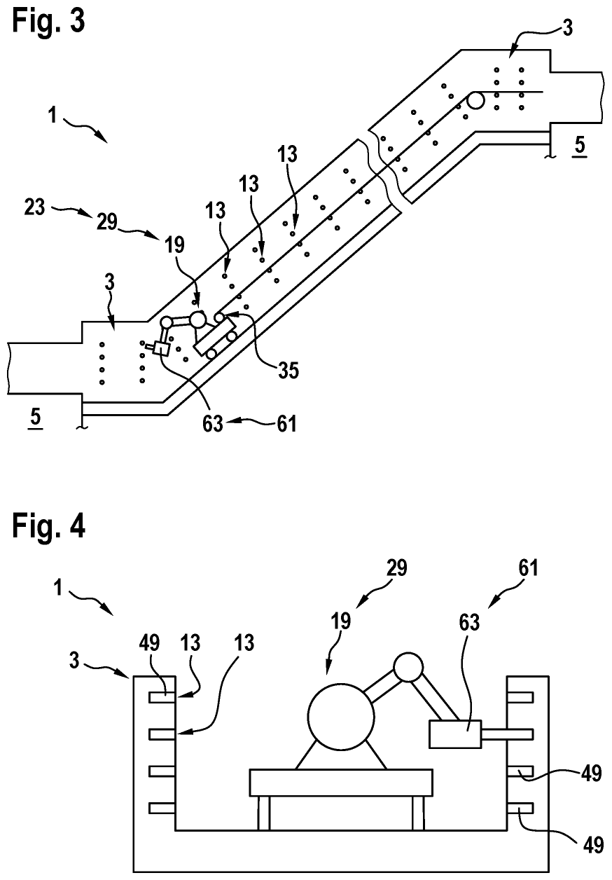

FIG. 3 shows a longitudinal sectional view of a passenger transport system during an assembly stage of an installation method according to one embodiment of the present invention.

FIG. 4 shows a cross-sectional view of the passenger transport system from FIG. 3.

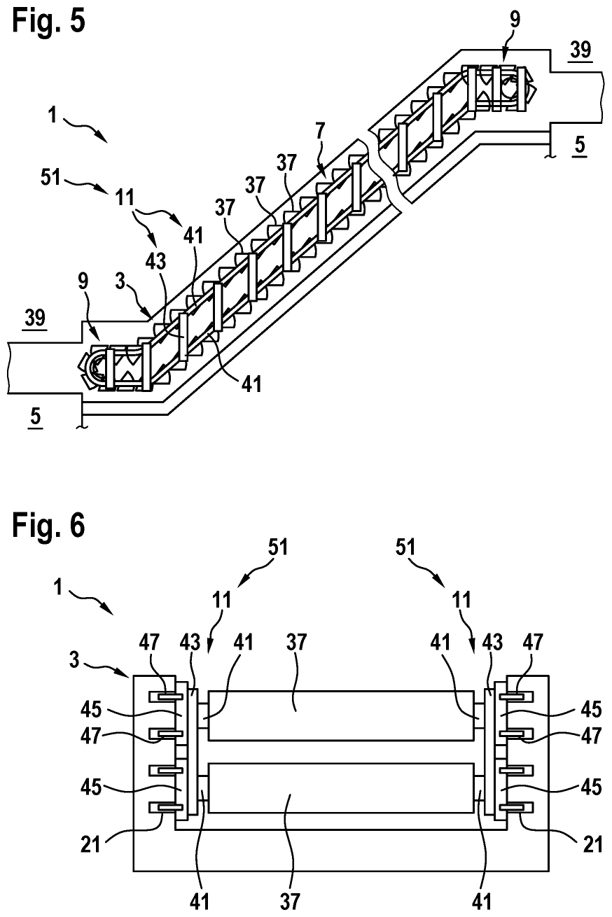

FIG. 5 shows a longitudinal sectional view of a passenger transport system installed using an installation method according to one embodiment of the present invention, and

FIG. 6 shows a cross-sectional view of the passenger transport system from FIG. 5.

The figures are merely schematic and not true to scale. The same reference signs indicate the same or equivalent features.

FIGS. 1 and 2 show a passenger transport system 1 in the form of an escalator during an initial stage of an installation method. FIGS. 3 and 4 show the passenger transport system 1 during a later stage of the installation method. Details of the installation method will be explained below.

The fully installed passenger transport system 1 is shown highly schematized in FIGS. 5 and 6. It comprises a revolving conveyor belt 7 having a plurality of tread units 37 coupled to one another, by means of which passengers (not shown) can be transported between floors in a building 5 along a transport path 9. At each of the opposite ends of the transport path 9 there are access regions 39 via which passengers can enter or exit the conveyor belt 7. The conveyor belt 7 is deflected at opposite ends of the transport path 9. Balustrades are usually arranged on both sides of the conveyor belt 7 and parallel thereto, on each of which a handrail is arranged so as to be movable in a revolving manner (not shown in the drawings for reasons of clarity).

In contrast to most conventional passenger transport systems, the passenger transport system 1 described herein does not comprise a supporting structure in the form of a conventional truss structure, via which the weight of the passenger transport system, including the load acting thereon, is transferred to end-face bearing members in the building 5. Instead, a receiving structure 3 is provided in the building 5 so as to be integrally incorporated therein, on which the passenger transport system 1 is installed and held.

In the example shown, this receiving structure 3 that is provided is designed as an elongated trough with a U-shaped cross section and made of concrete reinforced with rebars. The provided receiving structure 3 is designed, on the one hand, to absorb the weight of the passenger transport system 1 and the load acting thereon and, on the other hand, serves to enable supporting components 11 to be fastened thereto in a suitable manner, by means of which supporting components the conveyor belt 7 can be adequately held, supported and/or guided along the transport path. The supporting components 11 collectively form a supporting structure 51 for the passenger transport system 1.

In the example shown highly simplified in FIGS. 5 and 6, the supporting components 11 include, among others:
(i) guide rails 41, for example in the form of elongated metal profiles, along which the tread units 37 of the conveyor belt 7 are guided along the transport path 9;
(ii) vertical beams 43, for example in the form of profiles capable of withstanding high mechanical loads, which hold the guide rails 41 and position them at a predetermined distance from one another;
(iii) adapter components 45, for example in the form of shims, which serve as intermediate pieces between the beams 43 and the provided receiving structure 3 and which are adapted to the geometric and/or structural conditions of the provided receiving structure 3; and
(iv) anchors 47, for example in the form of bolts or screws, used to anchor the adapter components 45 in bores 49 (see also FIG. 4) as anchoring structure 21 in the provided receiving structure 3.

The various supporting components 11 can be connected to one another to form a support structure 51 in order to transfer loads from the conveyor belt 7 to the provided receiving structure 3. However, the supporting structure 51 can be significantly simpler and in particular lighter than conventional supporting structures in the form of self-supporting and load-bearing truss structures.

Some of the supporting components 11, such as the guide rails 41 and the beams 43, can be provided as standard components, as can be used in many different passenger transport systems 1. However, other supporting components 11, such as the adapter components 45 and possibly also the anchors 47, can be kept in stock in various designs in a kind of range so that individually suitable supporting components 11 of this type can then be selected from the range for the installation of a specific passenger transport system, in order in particular to be able to take into account individual conditions in the provided receiving structure 3 in the building 5.

It should be noted that both the provided receiving structure 3 and the support structure 51 formed from various supporting components 11 for holding, supporting and/or guiding the conveyor belt 7 are shown only highly schematized in the figures. In real applications, a plurality of different supporting components 11 can be used to form the support structure 51. In particular, different adapter components 45, for example in the form of fastening brackets, consoles, shims, differently dimensioned concrete anchors, etc., can be kept in stock and used for the individual installation of the passenger transport system 1. Adapter components that can be used in a similar way are described, among other things, in the applicant's earlier patent application WO 2020/038915A1 .

In order to manufacture or install the passenger transport system 1, as shown in FIGS. 1 and 2, the receiving structure 3 present in the building 5 beforehand is first measured in order to determine its geometrical data and/or structural data. For this purpose, a device 23 has a special measuring apparatus 25.

The measuring apparatus 25 is configured to automatically measure surfaces of the provided receiving structure 3 in order to thereby determine the desired geometrical data. For this purpose, the measuring apparatus 25 can, for example, have a 3D scanner 53 which can determine distances from the surfaces of the provided receiving structure 3, for example using laser beams 56 or by means of a TOF camera. In this way, for example, a distance d between opposite legs of the U-shaped receiving structure 3 can be determined, wherein this distance can vary locally, for example due to production tolerances along the longitudinal extension of the provided receiving structure 3. By measuring it, for example, any unevennesses 55 on surfaces of the provided receiving structure 3 can also be detected and their dimensions can be determined.

The measuring apparatus 25 can further be configured to detect internal or hidden structures within the provided receiving structure 3, such as iron reinforcements 57 (shown separately in FIGS. 1 and 2 only by way of example by dashed lines) and preferably to measure them with regard to their position, orientation and/or dimensions in order to then determine the desired structural data.

In order to measure the entire provided receiving structure 3, the measuring apparatus 25 can be designed as a displaceable carriage or slide and have a drive 33, by means of which the measuring apparatus 25 can be gradually displaced along the longitudinal extension of the provided receiving structure 3, i.e. along the transport path 9 to be spanned by the passenger transport system 1. As schematically illustrated in FIG. 1, the drive 33 may, for example, be in the form of a winch that can be rotated by a motor and onto which a cable 59, which is fixed in an upper region to the provided receiving structure 3 or adjacent parts of the building 5, can be gradually wound.

The geometrical data and/or structural data determined can then be used to suitably select suitable supporting components 11 (see FIGS. 5 and 6) from a plurality of available supporting components 11 in order to use them to hold, support and/or guide the conveyor belt 7 in the desired manner on the provided receiving structure 3.

In addition, the geometrical data and/or structural data can be analyzed or taken into account in order to determine, as shown in FIGS. 3 and 4, suitable fixing positions 13 on the provided receiving structure 3 where supporting components 11 can be fastened. The fixing positions 13 can be selected such that, on the one hand, the supporting components 11 and the components of the conveyor belt 7 connected thereto are held as desired relative to the provided receiving structure 3, and, on the other hand, for example, no anchors of supporting components 11 are arranged such that they collide with iron reinforcements 57 in the provided receiving structure 3.

In order to be able to appropriately select the supporting components 11 and to appropriately determine the fixing positions 13, the device 23 has a data processing apparatus 27. In principle, the data processing apparatus 27 can be housed directly in the measuring apparatus 25 or coupled thereto. Alternatively, the data processing apparatus 27 can be part of a designing apparatus 15 which is remote from the passenger transport system 1. Optionally, the device 23 can have a data communication apparatus 31 in order to be able to exchange data with the remote designing apparatus 15.

A digital twin data set 17 can be stored in the designing apparatus 15, in which data relating to properties of the passenger transport system 1 to be installed are stored. For example, information about dimensions of the various supporting components 11 available, in particular, for example, about positions of holding points, bores, etc. provided thereon, can be stored in the digital twin data set 17.

On the basis, on the one hand, of the geometrical data and/or structural data of the provided receiving structure 3 and, on the other hand, of the information stored in the digital twin data set 17, it is then possible to determine both suitable fixing positions 13 along the provided receiving structure 3 and suitable supporting components 11 for connecting the conveyor belt 7 to these fixing positions 13.

Subsequently, as illustrated in FIGS. 3 and 4, each of the selected supporting components 11 can be provided and fixed at the assigned fixing positions 13 to the provided receiving structure 3. The device 23 comprises a fixing apparatus 29 for this purpose. In the example shown, the fixing apparatus 29 comprises a robot 19. The robot 19 comprises a plurality of arms which can move relative to one another and at the end of which an anchoring tool 61, for example in the form of a drilling apparatus 63, is held. The fixing apparatus 29 further comprises a drive 35 similar to the drive 33 of the measuring apparatus 25, by means of which drive the fixing apparatus 29 can be gradually longitudinally moved along the provided receiving structure 3.

By means of the drilling apparatus 63, the robot 19 can create a suitable bore 49 as an anchoring structure 21, for example in side walls of the provided receiving structure 3, at each of the previously determined fixing positions 13. Subsequently, supporting components 11 in the form of dowels, concrete anchors, bolts, screws and the like in the form of anchorage 47 can then be inserted, for example screwed, into bores 49 of this type. Further supporting components 11, for example in the form of adapter components 45, such as shims, which have been suitably selected for the individual provided receiving structure 3, can then be fastened to these anchors 47. Finally, supporting components 11 in the form of standard components, such as the beams 43 and guide rails 41, can be attached thereto.

Finally, it should be noted that terms such as “having”, “comprising”, etc. do not preclude other elements or steps, and terms such as “a” or “one” do not preclude a plurality.

Furthermore, it should be noted that features or steps which have been described with reference to one of the above exemplary embodiments may also be used in combination with other features or steps of other exemplary embodiments described above. Reference signs in the claims should not be considered to be limiting.

1. A method for installing a passenger transport system in the form of an escalator or a moving walkway on a provided receiving structure, which structure is integrated in a building for holding the passenger transport system, wherein the passenger transport system comprises:
a conveyor belt for transporting passengers along a transport path, and
a plurality of supporting components for holding, supporting and/or guiding the conveyor belt along the transport path relative to the provided receiving structure, and wherein the method comprises:
determining geometrical data and/or structural data for the provided receiving structure by automatically measuring the provided receiving structure using a measuring apparatus,
automatically selecting supporting components from a plurality of available supporting components configured for holding, supporting and/or guiding the conveyor belt relative to the provided receiving structure at a plurality of different fixing positions along the transport path, and automatically determining a plurality of different fixing positions along the provided receiving structure, taking into account the geometrical data and/or structural data determined based on properties of the selected supporting components and
fixing each of the selected supporting components at an assigned fixing position of the plurality of fixing positions on the provided receiving structure.

2. The method according to claim 1, wherein the geometrical data and/or structural data determined for the provided receiving structure is transmitted to a designing apparatus in which a digital twin data set is stored, said digital twin data set including in data relating to properties of the passenger transport system to be installed, and wherein data from the digital twin data set is furthermore taken into consideration when determining the plurality of different fixing positions along the transport path at which the supporting components are to be fixed.

3. The method according to claim 2, wherein data from the digital twin data set is further taken into account when selecting the supporting components.

4. The method according to claim 2 and, wherein information about the selected supporting components and/or the determined fixing positions is further stored in the digital twin data set.

5. The method according to claim 1, wherein the geometrical data and/or structural data is determined by successively measuring the provided receiving structure at each of the plurality of different fixing positions along the transport path.

6. The method according to claim 5, wherein the measuring apparatus is successively moved along the transport path on the provided receiving structure for measuring purposes.

7. The method according to claim 1, wherein a robot automatically fixes each of the selected supporting components at the assigned fixing position of the plurality of different fixing positions on the provided receiving structure.

8. The method according to claim 7, wherein the robot is successively moved along the transport path on the provided receiving structure, and an anchoring structure is produced at each fixing position.

9. The method according to claim 8, wherein the robot fixes the supporting component to the associated anchoring structure immediately after the anchoring structure is created.

10. A device for installing a passenger transport system in the form of an escalator or a moving walkway on a provided receiving structure, which is integrated in a building for holding the passenger transport system, the passenger transport system comprising:
a conveyor belt for transporting passengers along a transport path, and
a plurality of supporting components for holding, supporting and/or guiding the conveyor belt relative to the provided receiving structure, and wherein the device comprises:
a measuring apparatus for determining geometrical data and/or structural data for the provided receiving structure by automatically measuring the provided receiving structure,
a data processing apparatus for automatically selecting supporting components from a plurality of available supporting components, which are provided for holding, supporting and/or guiding the conveyor belt relative to the provided receiving structure in a plurality of different fixing positions along the transport path, and for automatically determining a plurality of different fixing positions along the provided receiving structure, taking into account the geometrical data and/or structural data determined, based on properties of the chosen supporting components, and
a fixing apparatus for fixing each of the chosen supporting components at an assigned fixing position of the plurality of fixing positions on the provided receiving structure.

11. The device according to claim 10, further comprising: a data communication apparatus configured to transmit the geometrical data and/or structural data determined for the provided receiving structure to a designing apparatus in which a digital twin data set is stored, said digital twin data set in including data relating to properties of the passenger transport system to be installed, and/or receive data from the designing apparatus.

12. The device according to claim 10, wherein the measuring apparatus has a drive for moving the measuring apparatus along the transport path on the provided receiving structure.

13. The device according to claim 10, wherein the fixing apparatus comprises a robot for automatically fixing each of the chosen supporting components at the assigned fixing position of the plurality of different fixing positions on the provided receiving structure.

14. The device according to claim 13, wherein the fixing apparatus has a drive for moving the fixing apparatus along the transport path on the provided receiving structure, and wherein the robot is further configured to produce an anchoring structure at each fixing position.

15. The device according to claim 14, wherein the robot is further configured to fix a supporting component to the anchoring structure, wherein the supporting component is associated with the produced anchoring structure.
